(19) United States
(12) Patent Application Publication
(10) Pub. No.: US 2021/0187820 A1
(43) Pub. Date: Jun. 24, 2021

(54) METHOD FOR CONTINUOUSLY PRODUCING AN EMBOSSED WEB, AND RELATED INSTALLATION

(71) Applicant: F.D.S., Genay (FR)

(72) Inventor: Philippe SERRE, COLLONGES-AU-MONT-D'OR (FR)

(73) Assignee: F.D.S., Genay (FR)

(21) Appl. No.: 16/961,693

(22) PCT Filed: Jan. 11, 2019
(86) PCT No.: PCT/FR2019/050062

§ 371 Date: Jul. 12, 2020

(30) Foreign Application Priority Data
Jan. 12, 2018 (FR) 1850266

(51) Int. Cl. B29C 59/04; B29C 43/24; B29C 43/26; B29C 43/30; B29C 43/46; B29C 43/48; B29C 43/58

(52) U.S. Cl. CPC B29C 59/046; B29C 43/24; B29C 43/26; B29C 43/305; B29K 2105/04; B29C 43/48; B29C 43/58; B29C 2043/486; B29C 2043/5808; B29C 43/46

(57) ABSTRACT

The invention relates to a method for continuously producing an embossed web (2) from a primary web (3) having a surface face (3A) and an opposite back face (3B), wherein the primary web (3) is subjected to an operation for embossing the surface face (3A) using a heated embossing cylinder (5), the method being characterised in that the embossing operation comprises at least a first step of compressing the surface face (3A) of the primary web (3), said primary web (3) being in contact with the surface of the heated embossing cylinder (5) on at least one portion (Pc) of the perimeter of the latter, using a compression band (6) in surface contact with the back face (3B) of the primary web (3).

### TECHNICAL FIELD

The present invention relates to the general field of methods for manufacturing embossed webs. The invention also concerns the technical field of plants for implementing such methods.

More specifically, the invention concerns a method for the continuous manufacture of an embossed web starting from a pre-existing primary web with a thickness larger than 1 mm, said primary web comprising at least one layer of a thermoformable material and having an upside face and an opposite underside face, wherein said primary web is subjected to an operation of embossing said upside face using a heated embossing roll.

The invention further concerns a plant for the continuous manufacture of an embossed web starting from a pre-existing primary web with a thickness larger than 1 mm, said primary web comprising at least one layer of a thermoformable material and having an upside face and an opposite underside face, said plant comprising a device for embossing said upside face using a heated embossing roll.

### PRIOR ART

In the field of manufacture of embossed webs, a well-known method consists in subjecting a thermoformable layer, either one or both of the upside and underside faces thereof is to be embossed, to a substantially prolonged compressing force using an embossing plate bearing a relief negative pattern and heated. However, this method has the major drawback of not enabling a continuous manufacture of embossed webs, starting for example from rolled thermoformable webs, since, at best, it only enables a sequential and discontinuous processing of areas of said web with a surface area corresponding to the used embossing plate. Moreover, the implementation of such a known method is relatively slow. Also, it sometimes lacks reliability and repeatability in the positioning of the pattern, may cause considerable losses of matter, and sometimes, it also causes an undesirable alteration of the surface condition of the obtained embossed web (glossy effect, etc.).

That is why an alternative method has been proposed consisting in continuously subjecting the thermoformable web to be embossed to a pre-heating operation followed by a calendering operation between a heated engraved roll and a counter-roll.

While this method and its corresponding plant are satisfactory in general, in particular in comparison with the aforementioned discontinuous method «with the plate», it is still to be improved. Indeed, while the obtained embossed effect is satisfactory when the used thermoformable web has a small thickness, typically smaller than one millimeter, some defects could appear when the thickness of the thermoformable web is large and exceeds one millimeter. When the thickness of the thermoformable web exceeds one millimeter, it actually becomes necessary, in order to obtain an embossed effect that is deep enough using such a known method, to bring in a large amount of calories to the core of the thermoformable web during the pre-heating operation. A degradation of the surface condition of the web, and in particular burn effects, is then sometimes observed. Conversely, if this prior heat supply is insufficient, the core deformation of the web by the effect of the embossing roll is insufficient to guarantee the obtainment of a deep and perfectly defined embossed effect.

Consequently, the objects assigned to the present invention aim at addressing the aforementioned drawbacks and at providing a new method and a new plant that enable the continuous manufacture of embossed webs having an excellent embossed effect from thermoformable webs with a large thickness, durable and well-marked, without any degradation of the surface condition of the latter.

Another object of the invention aims at providing a new method and a new plant that enable the continuous manufacture of embossed webs having a particularly deep and well-defined embossed pattern.

Another object of the invention aims at providing a new method and a new plant that enable the continuous manufacture of embossed webs starting from thermoformable webs with quite varied natures and compositions.

Another object of the invention aims at providing a new method and a new plant that enable the continuous manufacture of embossed webs, at a satisfactory rate and for a mastered production cost.

### DISCLOSURE OF THE INVENTION

The objects assigned to the invention are achieved by means of a method for the continuous manufacture of an embossed web starting from a pre-existing primary web with a thickness larger than 1 mm, said primary web comprising at least one layer of a thermoformable material and having an upside face and an opposite underside face, wherein said primary web is subjected to an operation of embossing said upside face using a heated embossing roll, said method being characterized in that said embossing operation comprises at least one first step of compressing said upside face of the primary web in contact with the surface of said heated embossing roll over at least one portion of the perimeter of the latter using a compression band in surface contact with said underside face of the primary web, said embossing operation comprising a second step of compressing said primary web between said embossing roll and a main press counter-roll, said second compression step being immediately subsequent to said first compression step, said first and second compression steps being respectively carried out at predefined first pressure and second pressure, said second pressure being higher than or equal to said first pressure.

The objects assigned to the invention are also achieved by means of a plant for the continuous manufacture of an embossed web starting from a pre-existing primary web with a thickness larger than 1 mm, said primary web comprising at least one layer of a thermoformable material and having an upside face and an opposite underside face, said plant comprising a device for embossing said upside face using a heated embossing roll, said plant being characterized in that said embossing device comprises a compression band designed and arranged so as to come into surface contact with said underside face of the primary web and exert a first force, corresponding to a predefined first pressure, for compressing said upside face in contact with the surface of said heated embossing roll over at least one portion of the perimeter of the latter, said embossing device comprising a main press counter-roll positioned downstream of said surface contact and designed and arranged so as to exert a second force, corresponding to a predefined second pressure, for compressing said primary web between said embossing roll and said main press counter-roll, said second pressure being higher than or equal to said first pressure.

### BRIEF DESCRIPTION OF THE DRAWINGS

Other objects and advantages of the invention will appear better on reading the following description, as well as using the appended figures, provided only for illustrative and non-limiting purposes, and which schematically illustrates a preferred embodiment of the plant according to the invention, which plant is preferably intended for the implementation of the method according to the invention.

### BEST WAY TO CARRY OUT THE INVENTION

According to a first aspect, the invention concerns a method for manufacturing an embossed web 2 starting from a pre-existing primary web 3, that is to say from a pre-constructed solid web with a specific mechanical strength and with a composition and nature preferably identical to those of the obtained embossed web 2.

In general, the term «web» preferably refers, in the context of the invention, to a surface set, that is to say with a large length, a large section and a generally uniform but small thickness compared to the width and to the length, and advantageously featuring a specific mechanical strength.

Having an upside face 3A and an opposite underside face 3B, the primary web 3 concerned by the method according to the invention has a thickness larger than (or equal to) 1 mm, and preferably larger than 1.5 mm. Preferably, this thickness will be considered as the average distance (measured for example using a caliper) that separates said upside 3A and underside 3B faces of the primary web 3 when the latter is laid flat and at rest, in the absence of any particular compressing force exerted on the primary web 3 and at ambient temperature. Preferably, said primary web 3 is a soft surface web, that is to say it is substantially deprived of any specific stiffness. More specifically and advantageously, said primary web 3 is in the form of a long band featuring enough softness and flexibility so that it could be wound into a coil or folded on itself.

The method according to the invention is a continuous manufacturing method. Thus, it advantageously consists of an industrial method, preferably automated, enabling a substantially uninterrupted processing of large dimensions, and in particular large lengths, of a given primary web 3.

In other words, the method of the invention thus consists in continuously forming a relief pattern, with a substantially pronounced amplitude (depth), at the surface of a primary web 3, which has a large thickness, for example in comparison with of a primary web 3 that would be formed by a conventional textile cloth, such as a fabric or a paper sheet, whose thickness is generally smaller than 1 mm.

According to the invention, said primary web 3 comprises at least one layer of a thermoformable material, that is to say a layer formed by a material prone to undergo a hot forming, in particular across the thickness of said layer, and keep the deformed state conferred thereon after cooling. Thus, it is the hot forming of this thermoformable material layer that will confer (or at least will help conferring) an embossed effect on the web obtained on completion of the method according to the invention. Preferably, said thermoformable material of the primary web 3 is a foam (solid cellular material), preferably compressible (for example, a polyurethane or polyethylene soft foam), or a non-woven material, whether needle-punched or not. Typically, the softening or melting temperature of said thermoformable material is comprised between 80 and 250° C.

Preferably, said primary web 3 is a multi-layer web, that is to say it is formed by a stacked assembly of a plurality of surface layers distinct from one another, these layers preferably extending according to respective planes substantially parallel to one another. Advantageously, the different layers thereby composing the primary web preferably have different natures or properties, so that the primary web 3 advantageously forms a complex. Still more preferably, the primary web 3 may thus comprise, besides said thermoformable material layer, at least one textile layer. Thus, for example, said primary web 3 therefore may form a foam/textile complex. As such, this textile layer is not necessarily thermoformable.

Said textile layer, or cloth, may be woven or non-woven (for example a hot-melt non-woven layer), synthetic or natural. In particular, it may be obtained by any known method, and for example by knitting, by weaving, by a papermaking process (non-woven cloth «wet laid») or else through a dry process according to an aerodynamic process (non-woven cloth «air laid») of natural (cotton, linen, wool, silk, cellulose, etc.), synthetic (polyester, polyamide, aramid, glass, carbon, stainless steel, etc.) fibers or yarns, or of a mixture of such natural or synthetic fibers (or yarns). Advantageously, said textile layer then may form a surface layer of said primary web 3, and preferably the upside face 3A of the latter, whereas said thermoformable material layer will form the underside face 3B or an inner layer of the primary web 3.

Alternatively, or complementarily, the primary web 3 may comprise, besides said thermoformable material layer, a non-textile layer formed, for example, by a soft plastic or metallic sheet.

In order to obtain said embossed web 2 according to the method of the invention, the primary web 3 is subjected to an operation of embossing the upside face 3A of the primary web 3 using a heated embossing roll 5, the latter rotating, preferably at a predefined and constant speed. The surface of the embossing roll 5 is provided with an engraved negative pattern, and it is heated and maintained on temperature using any known means. Preferably, the temperature of the surface of the embossing roll 5, during said embossing operation, is lower than or equal to the softening or melting temperature of said thermoformable material of the primary layer 3, and still preferably comprised between 50° C. and 250° C.

More specifically, the embossing operation of the method according to the invention comprises at least one first step of compressing the upside face 3A of the primary web 3 in contact with the surface of said embossing roll 5, over at least one portion Pc of the perimeter of the latter, using a compression band (or belt) 6 which is in surface contact with the underside face 3B of the primary web 3.

Herein, preferably, «perimeter» should be understood as the outer perimeter of the embossing roll 5, measured at the level of the ridges of the pattern engraved at the surface thereof. Preferably flexible enough so as to be able to be partially wound around the embossing roll 5, said compression band 6 is positioned opposite the surface of said embossing roll 5 so as to face a non-negligible portion of the perimeter of the latter. During said first compression operation, said compression band 6 therefore comes into surface (preferably continuous) contact with the underside face 3B of the primary web 3, so that the primary web 3 is interposed between the embossing roll 5 and the compression band 6 during said first compression step. During the first compression step of the embossing operation of the method according to the invention, a determined surface area of the upside face 3A of the primary web 3 is thus brought into contact with and pressured under pressure against the engraved and hot surface of the embossing roll 5 using said compression band 6, the primary web 3 and the compression band 6 being partially wound together around the embossing roll 5.

In contrast with a conventional embossing operation by calendering, in which a primary web is brought into an almost linear contact with an embossing roll, the embossing operation of the method according to the invention thus comprises a first compression step which may advantageously be qualified as «surface» compression step.

Thus, the invention is based on the implementation of a surface compression of the primary web 3 against the embossing roll 5 with enough pressure to achieve an embossing of the primary web 3, that is to say enough pressure to obtain the desired relief patterns. Hence, the pressure implemented by the compression band 6 is high enough so as to impart to the primary web 3 a relief pattern (embossing) over its upside face 3A, such that it is different from a pressure aiming for example a mere polishing of the underside face.

Advantageously, the compression band 6 runs at the same speed as the primary web 3 and the engraved surface of the embossing roll 5. Preferably, the compression band 6 has a width larger than or equal to the width of the considered primary web 3. Preferably, said compression band 6 is a continuous band, that is to say endless, closed on itself, which facilitates the continuous implementation of the method of the invention. Preferably, the face of the compression band intended to come into compressive contact with the primary web 3 is substantially smooth, but may alternatively feature recesses and reliefs to imprint a specific texture at the underside face 3B.

According to one variant, the compression band 6 is a heat-insulating band, so as to enable a heat exchange through said compression band 6, in particular during said first compression step, and still more particularly in the preferred case, which will be disclosed hereinafter, where the method according to the invention comprises a step of heating the compression band 6. Preferably, the compression band 6 is a metallic band, advantageously made of steel, and even more advantageously of a steel alloy. According to an alternative variant, said compression band 6 is a heat-insulating band, that is to say it has a low thermal conductivity, in order to limit, on the contrary, the heat loss through the underside face 3B of the primary web 3 during said first compression step. For example, the compression band 6 may then be made by weaving or needle-punching of suitable mineral and/or organic fibers with the desired thermal conductivity and mechanical strength properties.

Preferably, said portion Pc of the perimeter of said embossing roll 5, over which the upside face 3A of the primary web 3 is brought into contact with the surface of the embossing roll 5, is defined by an arc angle θ of the embossing roll 5 comprised between about 72° and about 288° (i.e. a portion Pc of the perimeter comprised between about ⅕ and about ⅘ of the perimeter of said embossing roll 5). Still preferably, said portion Pc of the perimeter of said embossing roll 5 is defined by an arc angle θ of the embossing roll 5 at least equal to about 90° (namely about ¼ of the perimeter) and, even more preferably, equal to about 270° (namely about ¾ of the perimeter).

For a given embossing roll diameter, the first compression step of the method according to the invention thus implements a first compression area of the primary web 3 between said embossing roll 5 and said compression band 6 whose width is quite larger than the compression area generally implemented in the case of a conventional embossing method by calendering. This compression area width is herein considered as being the dimension of the compression area in the running direction of the primary web 3. For example, for an embossing roll with a 700 mm diameter, the first compression area implemented during the first compression step of the method according to the invention may advantageously have a width comprised between about 440 and about 1760 mm (in contrast with less than 30 mm, found in general for a conventional embossing method by calendering).

Correlatively, at comparable rotational speeds of the embossing roll, said first compression step allows for a duration of contact and compression of the primary web 3 against the engraved and hot surface of the embossing roll 5 which is significantly longer than the contact duration offered by a conventional embossing method by calendering (typically less than one second, and even less than one-tenth of a second). Advantageously, said first compression step, and therefore the contacting and compression of a given point of said primary web 3 with the embossing roll 5, is carried out over a period at least equal to 1 s, and preferably longer than or equal to 5 s.

Advantageously, at a given point of said first compression area, the compression band 6 exerts a first force, corresponding to a predefined first pressure P1, for compressing the primary web 3 in contact with the surface of the embossing roll 5, which is predefined and substantially constant. Preferably, said first compression step is thus carried out at a predefined first pressure P1, which is advantageously comprised between 150 and 3000 daN/m². Preferably, said first pressure P1 should be considered herein as an average value of the pressure exerted by the compression band 6 against the primary web 3 at the level of said first compression area.

Of course, the duration of said first compression step, as well as said first average pressure P1, may advantageously be selected, modulated, according to the thickness and nature of the considered primary web 3 (and in particular of its thermoformable material layer), and according to the amplitude of the embossed effect that is desired to be conferred on the primary web 3.

Hence, it is understood from the foregoing that during said first compression step of the embossing operation of the method according to the invention, the primary web 3 is thus simultaneously subjected to considerable compressing force field and heat flow, advantageously controlled and continuous, and that for a relatively long duration of contact with the embossing roll 5, typically longer than 1 s and, preferably, longer than or equal to 5 s. Thus, a particularly homogeneous and continuous heat transfer throughout the entire thickness of the primary web 3 (and in particular at the core of its thermoformable material layer) is promoted, as the pattern engraved at the surface of the embossing roll 5 is transferred to the upside face 3A of the primary web 3. Thus, an embossed web 2 is obtained having a particularly well marked and durable embossed effect, and a substantially homogeneous surface condition. In particular, it has been observed that said first compression operation allows limiting and even totally suppressing the burn effects, as well as guaranteeing an excellent average flatness of the underside face of the obtained embossed web 2.

In order to improve the depth and the definition of the imparted embossed patterns, the embossing operation of the method according to the invention preferably comprises a second step of compressing said primary web 3 between the embossing roll 5 and a press counter-roll 13 (or main counter-roll 13). Distinct from said first compression step, and advantageously carried out after the latter, said second compression step advantageously corresponds to a complementary embossing operation by calendering, which promotes the consolidation of the embossed effect imparted to the primary web 3 by the embossing roll 5 during the first compression step. Thus, unlike the first compression step, this second compression step advantageously consists in the application of a second local force for compressing the primary web 3, between the respective contact areas of the embossing roll 5 and of the main press counter-roll 13 with the latter, that is to say the implementation of a second compression area with a relatively small width (preferably, in the range of 1 to 30 mm). Thus, it is advantageously possible to qualify said second compression step as a «linear» or «almost-linear» compression step. Preferably, said second compressing force is exerted according to a direction normal to said primary web 3. Optionally, the main press counter-roll 13 may be provided at the surface thereof with a soft material coating, for example made of an elastomer, in particular so as to optimize the width of the second compression area formed between the embossing roll 5 and the main press counter-roll 13, and to promote the transmission of the mechanical forces.

Advantageously, this second compression step is immediately subsequent to the first compression step, and preferably terminates said embossing operation. Preferably, during said second compression step, said compression band 6 is interposed between the embossing roll 5 and the main press counter-roll 13. Thus, said second compression step is advantageously carried out whereas the primary web 3 is still held pressed against the embossing roll 5 by the compression band 6, so that the main press counter-roll 13 exerts said second compressing force on the primary web 3 and on the compression band 6 in surface contact with the latter. However, said second compression step may possibly be carried out before completion (nonetheless preferably just before the completion) of said first compression step, that is to say, simultaneously, combined with the first compression step. Indeed, it has been observed that such a juxtaposition (or possibly overlapping) of said first and second compression steps advantageously allows avoiding, between these two compression steps, any abrupt discontinuity of the pressure and heat flow conditions to which the primary web 3 is subjected during the embossing operation. Thus, the apparition of structural and visual defects, that such considerable and quick pressure or temperature variations between said first and second compression steps could cause, is limited.

Advantageously, said second compression step is respectively carried out at a predefined second pressure P2 and preferably maintained constant over time. Preferably, said second pressure P2 is defined and regulated by the application of a force exerted by a cylinder (or any other known means) on the axis of said main press counter-roll 13 according to a direction normal to the surface of the embossing roll 5. Preferably, said second pressure P2 is higher than or at least equal to the first pressure P1 at which said first compression step is carried out. Even more preferably, said second pressure P2 is strictly higher, and even significantly higher (for example, between 20 and 1000 times higher), than said first pressure P1. Indeed, it has been observed that such a feature is particularly advantageous for the definition of the embossed effect. Of course, said first and second pressures may advantageously be selected and modulated in particular according to the thickness or the nature of the primary web 3 to be embossed, or else according to the amplitude of the desired embossed effect.

Optionally, the embossing operation of the method according to the invention may comprise, prior to said first compression step, a step of pre-compressing the primary web 3 between the embossing roll 5 and a press counter-roll (distinct from the main press counter-roll 13 intended for the implementation of the second compression step). As will be shown hereinafter, this press counter-roll for carrying out said pre-compression step may be coincident with a feed roll 8 of the compression band 6. Advantageously, it will then constitute an input counter-roll.

Thus, this pre-compression step advantageously consists in the application of a local force for pre-compressing the primary web 3, between the respective contact areas of the embossing roll 5 and of the input press counter-roll with the latter («linear» or «almost-linear» compression). Advantageously, said pre-compression step corresponds to an operation of pre-embossing by calendering, which advantageously marks the start of said operation of embossing the primary web 3. Preferably, said pre-compressing force is exerted according to a direction normal to said primary web 3. Preferably, during said pre-compression step, said compression band 6 is interposed between the embossing roll 5 and said input press counter-roll.

Advantageously, said pre-compression step is carried out at a predefined pressure P3, and preferably maintained constant over time.

Optionally, the input press counter-roll intended for the implementation of the pre-compression step may be provided at its surface with a soft material coating, for example made of an elastomer, in particular so as to optimize the width of the pre-compression area formed between the embossing roll 5 and the input press counter-roll, and to promote the transmission of the mechanical forces.

Preferably, in the case where the compression band 6 is a heat-conductive band, the method according to the invention comprises a step of heating the compression band 6 so as to ensure, during said first compression step, heat supply to the primary web 3 by the underside face 3B via the compression band 6. Thus, advantageously, during the first compression step, a heat supply is ensured to the primary web 3 both by the underside face 3B via the compression band 6, and by the upside face 3A via the heated embossing roll 5. Hence, said step of heating the compression band 6 is concomitant, simultaneous, with said first compression step. Even more preferably, said step of heating the compression band 6 is carried out using a heating device 14 (such as for example an infrared radiant-heating type) positioned behind said compression band 6, opposite said portion Pc of the perimeter of the embossing roll 5 against which the primary web 3 is brought into contact and compressed during the first compression step. Thus, during said first compression step, a complementary heat supply is ensured to said primary web 3, by its underside face 3B, substantially homogenous and preferably continuous over the entirety of the portion of the primary web 3 that is in contact with the embossing roll 5. Such a complementary heat supply may turn out to be particularly interesting in the case where the primary web 3 is particularly thick and/or comprises a layer of a thermoformable material with a very low thermal conductivity (for example a polyurethane foam).

Typically, said step of heating the compression band 6 aims at heating the latter to a temperature comprised between 50 and 350° C. Possibly, during said heating step, said compression band 6 may be heated and maintained at a temperature higher than the temperature of the surface of the embossing roll 5.

Advantageously, said step of heating the compression band 6 may be preceded by an operation of pre-heating the latter, for example using a pre-heating device 15 such as a first radiant-heating device 16, in order to facilitate reaching the desired temperature of the compression band 6 as of the beginning of the first compression step.

Advantageously, the method according to the invention may comprise, prior to said first compression step, a step of pre-heating said primary web 3. During this step of pre-heating said primary web 3, the latter is preferably brought to a temperature preferably lower than or equal to the softening or melting temperature (and therefore to a temperature preferably lower than or equal to the degradation temperature) of the thermoformable material of said primary web 3. Typically, said step of pre-heating said primary web 3 is conducted at a temperature comprised between 50 and 220° C. Carried out for example through the passage of the primary web 3 opposite a pre-heating device 17 such as a second radiant-heating device 18 positioned upstream of said embossing roll 5, said pre-heating step then preferably immediately precedes said first compression step, so as to optimally promote the continuity of heat supply to the primary web 3 between said pre-heating step and said first compression step. Depending on the significance of the thickness of the primary web 3, such a step of pre-heating the latter advantageously allows preserving satisfactory production rates.

Depending on the targeted applications (nature and thickness of the primary web, depth of the desired embossed effect, etc.), said step of pre-heating the primary web 3 may advantageously complete or replace the step of pre-heating the compression band 6 considered hereinbefore.

The invention also concerns, as such, a plant 1 for the continuous manufacture of an embossed web 2. Advantageously, the considered plant 1 is a plant enabling the implementation of a method for the continuous manufacture of an embossed web 2 in accordance with the invention, so that the description disclosed in the foregoing in connection with the method according to the invention remains valid and applicable, mutatis mutandis, to the present plant 1.

In accordance with the invention, said plant 1 is designed so as to enable the continuous manufacture of an embossed web 2 starting from a pre-existing primary web 3 with a thickness larger than 1 mm, said primary web 3 comprising at least one layer of a thermoformable material and having an upside face 3A and an opposite underside face 3B, as previously described in connection with the method according to the invention. Preferably, it consists of an industrial plant, advantageously automated, designed so as to process, in a substantially uninterrupted manner, large dimensions of a given primary web.

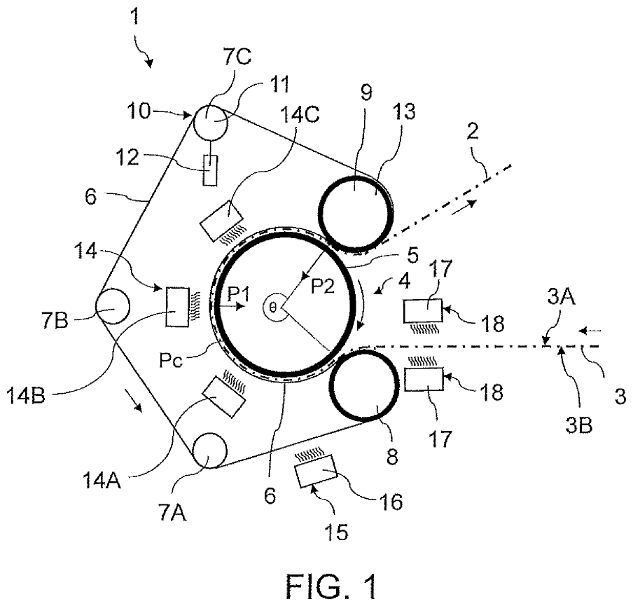

A particularly preferred embodiment of the plant 1 according to the invention is schematically illustrated in FIG. 1. The arrows present in FIG. 1 indicate the preferred direction of progress of the primary web 3 and of the embossed web 2 obtained from the latter, relative to the different devices and other components of said plant 1. The terms «upstream» and «downstream» used in the present description should preferably be understood with regards to the direction of progress indicated by these arrows (and independently of the relative positioning in space of either one of said devices or components).

In accordance with the invention, said plant 1 comprises a device 4 for embossing the primary web 3, and in particular the upside face 3A of the latter, using a heated (that is to say heater) embossing roll 5. Said embossing roll 5 is advantageously metallic, for example made of steel, with or without a surface finishing. The diameter of the embossing roll 5 is typically comprised between 200 and 1000 mm.

Preferably, the embossing roll 5 is provided with an internal heating system (not illustrated) for heating the surface of said embossing roll 5 to a predefined temperature, preferably comprised between 50° C. and 250° C. Advantageously, said plant 1 also comprises a system (not illustrated) for monitoring and regulating the temperature of the surface of the embossing roll 5.

As mentioned hereinbefore in connection with the method according to the invention, the embossing roll 5 is further provided at its surface with an engraved negative pattern, whose overall aspect is not specifically restricted, and whose average depth is typically comprised between 1 and 50 mm. Preferably, said embossing roll 5 is removable and interchangeable, in order to ensure an easy maintenance or replacement thereof, for example with an embossing roll 5 having a different diameter and/or bearing a different engraved pattern at its surface.

Besides said embossing roll 5, said embossing device 4 of the plant 1 according to the invention comprises a compression band 6. Positioned opposite said embossing roll 5, and in particular opposite a portion of the surface of the latter, said compression band 6 is designed and arranged so as to come into surface contact with said underside face 3B of the primary web 3 and exert a first force for pre-compressing said upside face 3A in contact with the surface of said heated embossing roll 5 over at least one portion Pc of the perimeter of the latter. Thus, said compression band 6 is advantageously intended to enable the implementation of the first compression step of the method according to the invention, as the latter has been described in detail hereinbefore.

As previously described in connection with the method according to the invention, said compression band 6 is an advantageously flexible band, so that it could be wound at least partially around the embossing roll 5, and thus face a non-negligible portion of the perimeter of the latter. Preferably, said compression band 6 is a continuous, that is to say endless, band, closed on itself, which allows facilitating the design of the plant 1 and mastering the bulk thereof.

According to one variant, the compression band 6 is a heat-conductive band, and for example a metallic band, advantageously made of steel, and even more advantageously made of a steel alloy. According to an alternative variant, said compression band is, on the contrary, a heat-insulating band, that is to say it has a low thermal conductivity. As considered hereinbefore, the compression band 6 may then be made, for example, by weaving or needle-punching of suitable mineral and/or organic fibers.

Preferably, the compression band 6 is removable and interchangeable, in order to ensure an easy maintenance or replacement thereof. Furthermore, the compression band 6 may advantageously have undergone a specific surface finishing, in particular to limit the risk of adhesion of the underside face 3B of the primary web 3 (for example, by deposition of a film of an anti-stick material, such as PFTE or the same) and/or, where appropriate, to improve the thermal properties thereof.

As illustrated, said compression band 6 is preferably supported and guided by a plurality of deflection rolls 7A, 7B, 7C, whose relative position is advantageously adjustable. Advantageously, said compression band 6 is maintained partially wound around said embossing roll 5, over the length of said portion Pc of the perimeter of the latter, using a feed roll 8 and a transfer roll 9. The feed roll 8 and/or the transfer roll 9, possibly as well as the deflection rolls 7A, 7B, 7C, may advantageously be provided at the surface thereof with a soft material coating, for example made of an elastomer.

The plant 1 according to the invention being intended for the processing of a pre-existing primary web 3 with a large thickness, and in particular larger than (or equal to) 1 mm, said compression band 6 and said embossing roll 5 are arranged relative to one another so as to enable the interposition of the primary web 3 between the compression band 6 and the surface of the embossing roll 5, when said primary web 3 and compression band 6 are wound around said embossing roll 5, along said portion Pc of the perimeter of the latter.

Preferably, the length of said portion Pc of the perimeter of the embossing roll 5 is predefined and adjustable. As it comes out from the appended figure, said portion Pc is advantageously defined by the position and relative spacing of the feed roll 8 and of the output roll 9 along the circumference of the embossing roll 5. More specifically and advantageously, said portion Pc of the perimeter of said embossing roll 5 is advantageously defined by an arc angle θ of the embossing roll 5 comprised between about 72° and about 288° (namely between ⅕ and ⅘ of the perimeter of said embossing roll 5). Preferably, said compression band 6 is arranged opposite said embossing roll 5 and follows the contour of the latter over at least one-quarter, and still preferably over three-quarters, of the perimeter of said embossing roll 5 (which corresponds to an arc angle θ larger than or equal to 90°, and preferably equal to 270° C.). As previously introduced in connection with the method of the invention, such an arrangement of the compression band 6 advantageously allows forming between the latter and the embossing roll 5 a particularly large first compression area, with a width advantageously comprised between 440 and 1760 mm, in particular according to the selected diameter of the embossing roll 5.

Advantageously, the plant 1 comprises a first device 10 for monitoring and regulating the magnitude of said first compressing force, corresponding to said first average pressure P1, exerted by the compression band. Preferably, the first monitoring and regulation device 10 is designed so as to monitor and regulate the tension of the compression band 6. According to the illustrated preferred embodiment, said first monitoring and regulation device 10 advantageously comprises a tensioner roll 11, possibly coincident with one of said deflection rolls 7A, 7B, 7C, and whose position is preferably controlled by a cylinder-type actuator 12.

Preferably, said embossing device 4 comprises a press counter-roll 13 (or main counter-roll 13) designed and arranged so as to exert a second force, advantageously corresponding to a predefined second pressure P2, for compressing said primary web 3 between said embossing roll 5 and said main press counter-roll 13. Advantageously, said main press counter-roll 13 is intended to enable the implementation of the second compression step of the method according to the invention, as described hereinbefore. Typically, the diameter of said main press counter-roll 13 may advantageously be comprised between 100 and 500 mm. Preferably, the main press counter-roll 13 is designed so as to exert said second compressing force according to a direction normal to said primary web 3.

Preferably, said main press counter-roll 13 is positioned downstream of said surface contact, that is to say downstream of said embossing roll 5 and of the first compression area formed between the compression band 6 and the embossing roll 5. More specifically and in accordance with the embodiment illustrated in the figure, said main press counter-roll 13 is advantageously positioned immediately downstream of said surface contact, so that said second compressing force corresponding to the pressure P2 is exerted immediately subsequent to the first compressing force corresponding to the pressure P1, which in particular allows avoiding any untimely resumption of swelling, by elastic return, of said primary web, for an optimum end result in terms of dimensions and aesthetics.

Advantageously, as illustrated, said main press counter-roll 13 is arranged so as to exert said second force for compressing said primary web 3 between the embossing roll 5 and the main press counter-roll 13, said compression band 6 being interposed between the embossing roll 5 and the main press counter-roll 13. As mentioned hereinbefore in connection with the method according to the invention, the main counter-roll 13 thus exerts said second force for compressing the primary web 3 on the surface of the embossing roll 5 through said compression band 6. Even more preferably, said main press counter-roll 13 is coincident with the transfer roll 9 of the compression band 6, so as to simplify the design and limit the bulk of the plant 1. Alternatively, it may, on the contrary, be distinct from said transfer roll 8 and, for example, be arranged between said transfer roll 9 and feed roll 8 (yet preferably closer to the transfer roll 9 than the feed roll 8), opposite the portion Pc of the perimeter of the embossing roll 5 which is covered with said compression band 6, and in contact with the latter.

Optionally, the main press counter-roll 13 is provided at the surface thereof with a soft material coating, for example made of an elastomer, in particular so as to optimize the width of the second compression area formed between the embossing roll 5 and the main press counter-roll 13, and to promote a proper transmission of the mechanical forces.

Preferably, the plant 1 comprises a second device (not illustrated) for monitoring and regulating the magnitude of said second compressing force, that is to say of the second pressure P2, exerted by said main press counter-roll 13. Said second monitoring and regulation device may be designed either to create and keep constant a predefined relative spacing between the respective surfaces of the embossing roll 5 and of the main press counter-roll 13, or to control the force exerted by a cylinder (or the same, not illustrated) on the axis of said main press counter-roll 13 against said one of the primary web 3 and of the embossing roll 5. Advantageously, said first 10 and second devices for monitoring and regulating the respective magnitude of the first and second compressing forces are distinct and are designed so as to be able to be controlled independently of one another.

Optionally, said embossing device 4 may comprise a press counter-roll, distinct from the main press counter-roll 13 which is intended for the application of the aforementioned second compressing force, and is positioned upstream of said surface contact, that is to say upstream of said embossing roll 5 and of the first compression area formed between the compression band 6 and the embossing roll 5. This optional press counter-roll is preferably designed and arranged so as to exert a force, advantageously corresponding to a predefined pressure P3, for pre-compressing said primary web 3 between said embossing roll 5 and said optional press counter-roll. Advantageously, this press counter-roll is intended to enable the implementation of the pre-compression step of the method according to the invention. Preferably, this press counter-roll is then designed so as to exert said pre-compression force according to a direction normal to said primary web 3.

Preferably, said optional press counter-roll is arranged so as to exert said force for pre-compressing said primary web 3 between the embossing roll 5 and the press counter-roll, said compression band 6 being interposed between the embossing roll 5 and the press counter-roll. Thus, the press counter-roll exerts said force for pre-compressing the primary web 3 on the surface of the embossing roll 5 through said compression band 6. Even more preferably, said press counter-roll is coincident with the feed roll 8 of the compression band 6, so as to simplify the design and limit the bulk of the plant 1. It will then advantageously constitute an input counter-roll.

Optionally, the optional press counter-roll is provided at the surface thereof with a soft material coating, for example made of an elastomer, in particular so as to optimize the width of the pre-compression area formed between the embossing roll 5 and the press counter-roll, and promote a proper transmission of the mechanical forces.

Preferably, the plant 1 comprises a device 14 for heating said compression band 6, which is positioned behind said compression band 6, opposite said portion Pc of the perimeter of the embossing roll 5, around which the compression band 6 is wound. Preferably, the device 14 for heating said compression band 6 is provided with a temperature monitoring and regulation system.

As illustrated, said heating device 14 advantageously comprises a plurality of distinct heater elements 14A, 14B, 14C, preferably of the mid-infrared radiant-heaters type. In a particularly advantageous manner, said heater elements 14A, 14B, 14C are designed so as to be able to be controlled independently of one another, so as to ensure a perfect control of the temperature of the compression band 6. In this respect, each of said heater elements 14A, 14B, 14C is advantageously provided with its own temperature monitoring and regulation system (not illustrated). Preferably, the plant 1 of the invention comprises a device 15 for pre-heating said compression band 6. Preferably, said pre-heating device 15 is arranged upstream of the embossing roll 5 (with regards to the running direction of the compression band 6), advantageously in the immediate vicinity of the latter. Said device 15 for pre-heating the compression band 6 may be of any known type, such as for example a first radiant-heating device 16 type. Preferably, said device 15 for pre-heating said compression band 6 is provided with a temperature monitoring and regulation system.

Advantageously, the plant 1 comprises a device 17 for pre-heating said primary web 3. Said pre-heating device 17 is preferably arranged upstream of the embossing roll 5 (with regards to the running direction of the compression band 6), advantageously in the immediate vicinity of the latter so as to optimally promote the continuity of heat supply to the primary web 3, and opposite the upside face 3A and/or the underside face 3B of the primary web 3 (FIG. 1). Said device for pre-heating the primary web 3 may be of any known type, such as for example a second radiant-heating device 18 type. Preferably, said device 17 for pre-heating the primary web 3 is provided with a temperature monitoring and regulation system.

For example, said device 17 for pre-heating the primary web 3 may comprise one or several infrared radiant-heater(s), arranged opposite the upside face 3A and/or the underside face 3B of the primary web 3, and preferably positioned immediately upstream of the feed roll 8 of the compression band 6.

In fine, the method and plant according to the invention enable the continuous, quick, repeatable and effective manufacture of embossed webs having an excellent embossed effect, and that starting from thermoformable webs with large thicknesses (larger than 1 mm) and with quite varied natures and compositions. The obtained embossed webs have an excellent surface condition and a particularly deep and well-defined embossed pattern.

Moreover, independently of the implementation of the other features described herein, is also an invention on its own, a method for the continuous manufacture of an embossed web 2 starting from a pre-existing primary web 3, for example with a thickness larger than 1 mm, having an upside face 3A and an opposite underside face 3B, said primary web 3 being a multi-layer web comprising at least one layer of a thermoformable material and at least one textile layer (for example woven or non-woven, thermoformable or not), wherein said primary web 3 is subjected to an operation of embossing said upside face 3A using a heated embossing roll 5, said embossing operation comprising at least one first step of compressing said upside face 3A of the primary web 3 in contact with the surface of said heated embossing roll 5 over at least one portion Pc of the perimeter of the latter using a compression band 6 in surface contact with said underside face 3B of the primary web 3.

Indeed, it turns out that resorting to a step of compressing a primary web formed by a thermoformable material/textile complex (for example a foam/textile complex), in contact with the surface of a heated embossing roll, using specifically a compression band in surface contact with one of the faces of said complex, allows obtaining, continuously and at a high rate, a particularly deep, effective and accurate embossing, without any deterioration of the complex, in spite of the specific composite nature of the latter, including when it has a large thickness.

Particularly suitable for processing primary webs with large thicknesses, with quite varied natures and compositions, the plant according to the invention also has a particularly mastered bulk and allows for a relatively easy maintenance.

An embossed web, manufactured using a method and/or a plant in accordance with the invention, will find application in particular in the fields of coatings of seats for transportation (motor vehicle, etc.), furnishing, acoustic and thermal insulation systems, or else in the field of wall decorative coatings.

Possibility of Industrial Application

The invention finds its industrial application in the methods and plants for the continuous manufacture of embossed webs.

1. A method for the continuous manufacture of an embossed web (2) comprising: starting from a pre-existing primary web (3) with a thickness larger than 1 mm, said primary web (3) comprising at least one layer of a thermoformable material and having an upside face (3A) and an opposite underside face (3B), wherein said primary web (3) is subjected to an operation of embossing said upside face (3A) using a heated embossing roll (5), said method being characterized in that said embossing operation comprises at least one first step of compressing said upside face (3A) of the primary web (3) in contact with the surface of said heated embossing roll (5) over at least one portion (Pc) of the perimeter of the latter using a compression band (6) in surface contact with said underside face (3B) of the primary web (3), said embossing operation comprising a second step of compressing said primary web (3) between said embossing roll (5) and a main press counter-roll (13), said second compression step being immediately subsequent to said first compression step, said first and second compression steps being respectively carried out at predefined first pressure (P1) and second pressure (P2), said second pressure (P2) being higher than or equal to said first pressure (P1).

2. The manufacturing method according to claim 1, characterized in that said first compression step is carried out over a period at least equal to 1 s, and preferably longer than or equal to 5 s.

3. The manufacturing method according to claim 1, characterized in that, during said second compression step, said compression band (6) is interposed between said embossing roll (5) and said main press counter-roll (13).

4. The manufacturing method according to claim 1, characterized in that said second pressure (P2) is strictly higher than said first pressure (P1).

5. The manufacturing method according to claim 1, characterized in that said thermoformable material is a foam or a non-woven material, whether needle-punched or not.

6. The manufacturing method according to claim 1, characterized in that said primary web (3) is a multi-layer web.

7. The manufacturing method according to claim 1, characterized in that said primary web (3) comprises, besides said thermoformable material layer, at least one textile layer, for example woven or non-woven.

8. The manufacturing method according to claim 1, characterized in that said compression band (6) is a continuous band.

9. The manufacturing method according to claim 1, characterized in that said compression band (6) is a heat-conductive band, preferably metallic.

10. The manufacturing method according to claim 1, characterized in that said compression band (6) is a heat-insulating band.

11. The manufacturing method according to claim 1, characterized in that it comprises a step of heating said compression band (6) to ensure, during said first compression step, heat supply to said primary web (3) by said underside face (3B) via said compression band (6).

12. The manufacturing method according to claim 1, characterized in that said step of heating said compression band (6) is carried out using a heating device (14) positioned behind said compression band (6), opposite said portion (Pc) of the perimeter of the embossing roll (5).

13. The manufacturing method according to claim 1, characterized in that it comprises, prior to said first compression step, a step of pre-heating said primary web (3).

14. A plant (1) for the continuous manufacture of an embossed web (2) comprising: starting from a pre-existing primary web (3) with a thickness larger than 1 mm, said primary web (3) comprising at least one layer of a thermoformable material and having an upside face (3A) and an opposite underside face (3B), said plant (1) comprising a device (4) for embossing said upside face (3) using a heated embossing roll (5), said plant (1) being characterized in that said embossing device (4) comprises a compression band (6) designed and arranged so as to come into surface contact with said underside face (3B) of the primary web (3) and exert a first force, corresponding to a predefined first pressure (P1), for compressing said upside face (3A) in contact with the surface of said heated embossing roll (5) over at least one portion (Pc) of the perimeter of the latter, said embossing device (4) comprising a main press counter-roll (13) positioned downstream of said surface contact and designed and arranged so as to exert a second force, corresponding to a predefined second pressure (P2), for compressing said primary web (3) between said embossing roll (5) and said main press counter-roll (13), said second pressure (P2) being higher than or equal to said first pressure (P1).

15. The plant (1) according to claim 14, characterized in that said compression band (6) is arranged opposite said embossing roll (5) and follows the circumference of the latter over at least one-quarter, and preferably over three-quarters, of the perimeter of said embossing roll (5).

16. The plant (1) according to claim 14, characterized in that it comprises a first device for monitoring and regulating (10) the magnitude of said first compressing force.

17. The plant (1) according to claim 14, characterized in that it comprises a second device for monitoring and regulating the magnitude of said second compressing force.

18. The plant (1) according to claim 14, characterized in that said main press counter-roll (13) is arranged so as to exert said second compressing force on said primary web (3) between said embossing roll (5) and said main press counter-roll (13), said compression band (6) being interposed between said embossing roll (5) and said main press counter-roll (13).

19. The plant (1) according to claim 14, characterized in that said compression band (6) is a continuous band.

20. The plant (1) according to claim 14, characterized in that said compression band (6) is a heat-conductive band, preferably metallic.

21. The plant (1) according to claim 14, characterized in that said compression band (6) is a heat-insulating band.

22. The plant (1) according to claim 14, characterized in that it comprises a device (14) for heating said compression band (6), which is positioned behind said compression band (6), opposite said portion (Pc) of the perimeter of the embossing roll (5).

23. The plant (1) according to claim 14, characterized in that it comprises a device (17) for pre-heating said primary web (3) which is arranged upstream of said embossing roll (5).
